(19) United States
(12) Patent Application Publication
(10) Pub. No.: US 2018/0211121 A1
(43) Pub. Date: Jul. 26, 2018

(54) Detecting Vehicles In Low Light Conditions

(71) Applicant: Ford Global Technologies, LLC, Dearborn, MI (US)

(72) Inventors: Maryam Moosaei, Mishawaka, IN (US); Guy Hotson, Palo Alto, CA (US); Vidya Nariyambut Murali, Sunnyvale, CA (US); Madeline J. Goh, Palo Alto, CA (US)

(21) Appl. No.: 15/415,733

(22) Filed: Jan. 25, 2017

(51) Int. Cl. G06K 9/00; G06T 5/20; G06K 9/46; H04N 9/77; H04N 7/18; G01S 17/93; B60R 1/00; G05D 1/00; G05D 1/02

(52) U.S. Cl. CPC G06K 9/00825; G06T 5/20; G06K 9/4609; H04N 9/77; H04N 7/183; G01S 17/936; B60R 2300/80; G05D 1/0088; G05D 1/0238; G06K 9/4652; B60R 2300/105; B60R 2300/301; B60R 1/00

(57) ABSTRACT

The present invention extends to methods, systems, and computer program products for detecting vehicles in low light conditions. Cameras are used to obtain RGB images of the environment around a vehicle. RGB images are converted to LAB images. The “A” channel is filtered to extract contours from LAB images. The contours are filtered based on their shapes/sizes to reduce false positives from contours unlikely to correspond to vehicles. A neural network classifies an object as a vehicle or non-vehicle based the contours. Accordingly, aspects provide reliable autonomous driving with lower cost sensors and improved aesthetics. Vehicles can be detected at night as well as in other low light conditions using their head lights and tail lights, enabling autonomous vehicles to better detect other vehicles in their environment. Vehicle detections can be facilitated using a combination of virtual data, deep learning, and computer vision.

### CROSS-REFERENCE TO RELATED APPLICATIONS

Not applicable.

### BACKGROUND

### 1. Field of the Invention

This invention relates generally to the field of autonomous vehicles, and, more particularly, to detecting other vehicles in low light conditions.

### 2. Related Art

Autonomous driving solutions need to reliably detect other vehicles at night (as well as in other low light conditions) in order to drive safely. Most vehicle vision approaches use LIDAR sensors to detect other vehicles at night and in other low light conditions. LIDAR sensors are mounted on a vehicle, often on the roof. The LIDAR sensors have moving parts enabling sensing of the environment 360-degrees around the vehicle out to a distance of around 100-150 meters. Sensor data from the LIDAR sensors is processed to perceive a “view” of the environment around the vehicle. The view is used to automatically control vehicle systems, such as, steering, acceleration, braking, etc. to navigate within the environment. The view is updated on an ongoing basis as the vehicle navigates (moves within) the environment.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example environment that facilitates detecting another vehicle in low light conditions.

FIG. 3 illustrates a flow chart of an example method for detecting another vehicle in low light conditions.

FIG. 4A illustrates an example vehicle.

FIG. 4B illustrates a top view of an example low light environment for detecting another vehicle.

FIG. 4C illustrates a perspective view of the example low light environment for detecting another vehicle.

FIG. 5 illustrates a flow chart of an example method for detecting another vehicle in low light conditions.

### DETAILED DESCRIPTION

The present invention extends to methods, systems, and computer program products for detecting vehicles in low light conditions (e.g., at night).

Most vehicle based autonomous vision systems perform poorly both at night and in other low light conditions (e.g., fog, snow, rain, other lower visibility conditions, etc.). Some better performing vision systems use LIDAR sensors to view the environment around a vehicle. However, LIDAR sensors are relatively expensive and include mechanical rotating parts. Further, LIDAR sensors are frequently mounted on top of vehicles limiting aesthetic designs.

Camera sensors provide a cheaper alternative relative to LIDAR sensors. Additionally, a reliable camera-based vision system for detecting vehicles at night and in other low light conditions can improve the accuracy of LIDAR-based vehicle detection through sensor fusion. Many current machine learning and computer vision algorithms fail to detect vehicles accurately at night and in the other low light conditions because of limited visibility. Additionally, more advanced machine learning techniques (e.g., deep learning) require a relatively large quantity of labeled data, and procuring a large quantity of labeled data for vehicles at night and in other low light conditions is challenging. As such, aspects of the invention augment labeled data with virtual data for training.

A virtual driving environment (e.g., created using 3D modeling and animation tools) is integrated with a virtual camera to produce virtual images in large quantities in a short amount of time. Relevant parameters, such as, lighting and the presence and extent of vehicles, are generated in advance and then used as input to the virtual driving environment to ensure a representative and diverse dataset.

The virtual data of vehicles is provided to a neural network for training. When a real world test frame is accessed (e.g., in the red, green, blue (RGB) color space), the test frame is converted to a color-opponent color space (e.g., a LAB color space). The “A” channel is filtered with different filter sizes and contours extracted from the frame. The contours are filtered based on their shapes and sizes to help reduce false positives from sources such as traffic lights, bicycles, pedestrians, street signs, traffic control lights, glare, etc. The regions surrounding the contours at multiple scales and aspect ratios are considered as potential regions of interest (RoI) for vehicles. Heuristics, such as, locations of symmetry between contours (e.g., lights) can be used to generate additional RoIs.

A neural network (e.g., a deep neural network (DNN)) trained on the virtual data and fine-tuned on a small set of real-world data is then used for classification/bounding box refinement. The neural network performs classification and regression on the RGB pixels and/or features extracted from the RGB pixels at the RoIs. The neural network outputs whether or not each RoI corresponds to a vehicle, as well as a refined bounding box for the location of the car. Heavily overlapping/redundant bounding boxes are filtered out using a method, such as, non-maximal suppression, which discards low-confidence vehicle detections that overlap with high-confidence vehicle detections.

Accordingly, aspects of the invention can provide reliable autonomous driving with lower cost sensors and improved aesthetics. Vehicles can be detected at night as well as in other low light conditions using their head lights and tail lights, enabling autonomous vehicles to better detect other vehicles in their environment. Vehicle detections can be facilitated using a combination of virtual data, deep learning, and computer vision.

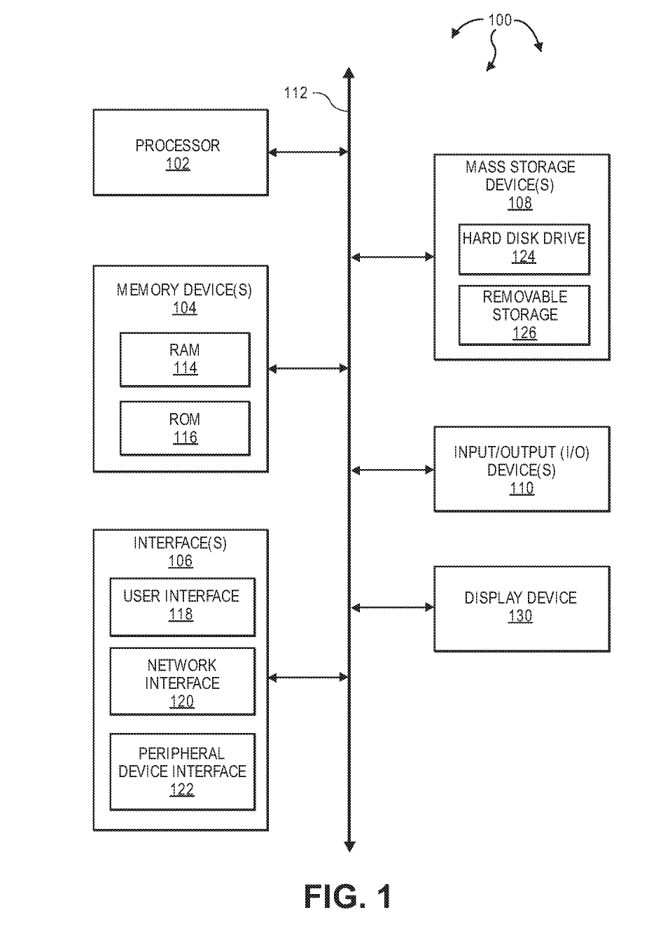

Aspects of the invention can be implemented in a variety of different types of computing devices. FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

In this description and the following claims, the “color-opponent process” is defined as a color theory that states that the human visual system interprets information about color by processing signals from cones and rods in an antagonistic manner. The three types of cones (L for long, M for medium and S for short) have some overlap in the wavelengths of light to which they respond, so it is more efficient for the visual system to record differences between the responses of cones, rather than each type of cone's individual response. The opponent color theory suggests that there are three opponent channels: red versus green, blue versus yellow, and black versus white (the last type is achromatic and detects light-dark variation, or luminance). Responses to one color of an opponent channel are antagonistic to those to the other color. That is, opposite opponent colors are never perceived together—there is no “greenish red” or “yellowish blue”.

In this description and the following claims, an “LAB color space” is defined as a color-opponent color space including a dimension L for lightness and dimensions a and b for color-opponent dimensions.

In this description and the following claims, an “RGB color model” is defined as an additive color model in which red, green and blue light are added together in various ways to reproduce a broad array of colors. The name of the model comes from the initials of the three additive primary colors, red, green and blue.

In this description and the following claims, an RGB color space is defined as a color space based on the RGB color model. In one aspect, in the RGB color space, the color of each pixel in an image may have a red value from 0 to 255, a green value from 0 to 255, and a blue value from 0 to 255.

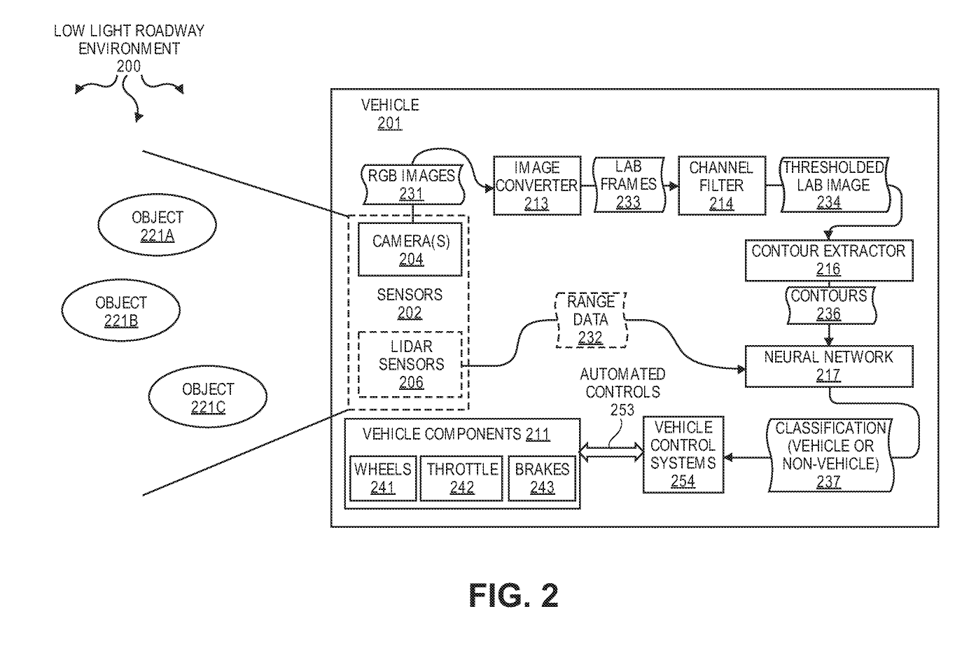

FIG. 2 illustrates an example low light roadway environment 200 that facilitates detecting another vehicle in low light conditions. Low light conditions can be present when light intensity is below a specified threshold. Low light roadway environment 200 includes vehicle 201, such as, for example, a car, a truck, or a bus. Vehicle 201 may or may not contain any occupants, such as, for example, one or more passengers. Low light roadway environment 200 also includes objects 221A, 221B, and 221C. Each of objects 221A, 221B, and 221C can be any of: roadway markings (e.g., lane boundaries), pedestrians, bicycles, other vehicles, signs, buildings, trees, bushes, barriers, any other types of objects, etc. Vehicle 201 can be moving within low light roadway environment 200, such as, for example, driving on a road or highway, through an intersection, in a parking lot, etc.

As depicted, vehicle 201 includes sensors 202, image converter 213, channel filter 214, contour extractor 216, neural network 217, vehicle control systems 254, and vehicle components 211. Each of sensors 202, image converter 213, channel filter 214, contour extractor 216, neural network 217, vehicle control systems 254, and vehicle components 211, as well as their respective components can be connected to one another over (or be part of) a network, such as, for example, a PAN, a LAN, a WAN, a controller area network (CAN) bus, and even the Internet. Accordingly, each of sensors 202, image converter 213, channel filter 214, contour extractor 216, neural network 217, vehicle control systems 254, and vehicle components 211, as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Sensors 202 further include camera(s) 204 and optional LIDAR sensors 206. Camera(s) 204 can include on or more cameras that capture video and/or still images of other objects (e.g., objects 221A, 221B, and 221C) in low light roadway environment 200. Camera(s) 204 can capture images in different portions of the light spectrum, such as, for example, in the visible light spectrum and in the InfraRed (IR) spectrum. Camera(s) 204 can be mounted to vehicle 201 to face in the direction vehicle 201 is moving (e.g., forward or backwards). Vehicle 201 can include one or more other cameras facing in different directions, such as, for example, front, rear, and each side.

In one aspect, camera(s) 204 are Red-Green-Blue (RGB) cameras. Thus, camera(s) 204 can generate images where each image section includes a Red pixel, a Green pixel, a Blue pixel. In another aspect, camera(s) 204 are Red-Green-Blue/Infrared (RGB/IR) cameras. Thus, camera(s) 204 can generate images where each image section includes a Red pixel, a Green pixel, a Blue pixel, and an IR pixel. The intensity information from IR pixels can be used to supplement decision making based on RGB pixels during the night, as well as in other low (or no) light environments, to sense roadway environment 200. Low (or no) light environments can include travel through tunnels, in precipitation, or other environments where natural light is obstructed. In further aspects, camera(s) 204 includes different combinations of cameras selected from among: RGB, IR, or RGB/IR cameras.

When included, LIDAR sensors 206 can sense the distance to objects in low light roadway environment 200 both in low light and other lighting environments.

Although camera(s) 204 can capture RGB video and/or images, the RGB color scheme may not sufficiently reveal information for identifying other vehicles in low (or no) light environments. Accordingly, image converter 213 is configured to convert RGB video and/or still images from an RGB color space to an LAB color space. In one aspect, image converter 213 converts RGB video into LAB frames. An LAB color space can be better suited for low (or no) light environments because the A channel provides increased effectiveness for detecting bright or shiny objects in varied low light or night-time lighting conditions.

As such, channel filter 214 is configured to filter LAB frames into thresholded LAB images. LAB frames can be filtered based on their “A” channel at one or more threshold values within the domain of the “A” channel. In one aspect, channel filter 214 filters the “A” channel with different sizes to account for different lighting conditions. For example, the “A” channel may be filtered with multiple different sizes (such as 100 pixels, 150 pixels, and 200 pixels) which would result in multiple corresponding different thresholded LAB images.

Contour extractor 216 is configured to extract relevant contours from thresholded LAB images. Contour extractor 216 can include functionality to delineate or identify the contours of one or more objects (e.g., any of objects 221A, 221B, and 221C) in low light roadway environment 200 from thresholded LAB images. In one aspect, contours are identified from one or more edges and/or closed curves detected within a thresholded LAB image. Contour extractor 216 can also include functionality for filtering contours based on size and/or shape. For example, contour extractor 216 can filter out contours having a size and/or a shape that are unlikely to correspond to a vehicle. Contour extractor 216 can select remaining contours as relevant and extract those contours.

Different filtering algorithms can be used to filter contours corresponding to different types of vehicles, such as, trucks, vans, cars, buses, motorcycles, etc. The filtering algorithms can analyze the size and/or shape of one or more contours to determine if the size and/or shape fits within parameters that would be expected for a vehicle. If the size (e.g., height, width, length, diameters, etc.) and/or shape (e.g., square, rectangular, circular, oval, etc.) does not fit within such parameters, the contours are filtered out.

For example, many, if not most, four wheel vehicles are over four feet wide but less than 8½ feet wide. Accordingly, a filter algorithm for cars, vans, or trucks can filter out objects that are less than four feet wide or more than 8½ feet wide, such as, for example, street signs, traffic lights, bicycles, buildings, etc.

Other filtering algorithms can consider the spacing and/or symmetry between lights. For example, a filtering algorithm can filter out lights that are unlikely to be headlights or tail lights.

In one aspect, thresholded LAB images can maintain an IR pixel. The IR pixel can be used to detect heat. A filter algorithm for motorcycles can use the IR pixel to select contours for motorcycles based on engine heat.

Contour extractor 216 can send relevant contours to neural network 217 for classification.

In one aspect, vehicle 201 also includes a cropping module (not shown). The cropping module can crop out one or more regions of interest from an RGB image that correspond to one or objects (e.g., objects 221A, 221B, and 221C) that pass through filtering at contour extractor 216. Boundaries of cropping can match or closely track contours identified by control extractor 216. Alternatively, cropping boundaries may encompass more (e.g., slightly more) than the contours extracted by contour extractor 216. When one or more regions are cropped out, the regions can be sent to neural network 217 for classification.

Neural network 217 takes one or more relevant contours and cam make a binary classification with respect to whether or not any of the one or more contours indicate the presence of a vehicle in low light roadway environment 200. The binary classification can be sent to vehicle control systems 254.

Neural network 217 can be previously trained using both real world and virtual data. In one aspect, neural network 217 is trained using data from a video game engine (or other components that can render three dimensional environments). The video game engine can be used to set up virtual roadway environments, such as, urban intersections, highways, parking lots, country roads, etc. Perspective views are considered from where cameras may be mounted on a vehicle. From the perspective views, virtual data is recorded for vehicle movements, speeds, directions, etc., within the three dimensional environment under various low light and no light scenarios. The virtual data is then used to train neural network 217.

Neural network module 217 can include a neural network architected in accordance with a multi-layer (or “deep”) model. A multi-layer neural network model can include an input layer, a plurality of hidden layers, and an output layer. A multi-layer neural network model may also include a loss layer. For classification of objects as vehicles or non-vehicles, values in extracted contours (e.g., pixel-values) are assigned to input nodes and then fed through the plurality of hidden layers of the neural network. The plurality of hidden layers can perform a number of non-linear transformations. At the end of the transformations, an output node yields an indication of whether or not an object is likely to be a vehicle.

Due at least in part to contour filtering and/or cropping, classification can be performed on limited portions of an image that are more likely to contain a vehicle relative to other portions of the image. Classifying limited portions of an image (potentially significantly) lowers the amount of time spent on classification (which can be relatively slow and/or resource intensive). Accordingly, detection and classification of vehicles in accordance with the present invention may be a relatively quick process (e.g., be completed in about 1 second or less).

In general, vehicle control systems 254 include an integrated set of control systems, for fully autonomous driving. For example, vehicle control systems 254 can include a cruise control system to control throttle 242, a steering system to control wheels 241, a collision avoidance system to control brakes 243, etc. Vehicle control systems 254 can receive input from other components of vehicle 201 (including neural network 217) and can send automated controls 253 to vehicle components 211 to control vehicle 201.

In response to a detected vehicle in low light roadway environment 200, vehicle control systems 254 can issue one or more warnings (e.g., flash a light, sound an alarm, vibrate a steering wheel, etc.) to a driver. Alternatively, or in combination, vehicle control systems 254 can also send automated controls 253 to brake, slowing down, turn, etc. to avoid the vehicle if appropriate.

In some aspects, one or more of camera(s) 204, image converter 213, channel filter 214, contour extractor 216, and neural network 217 are included in a computer vision system at vehicle 201. The computer vision system can be used for autonomous driving of vehicle 201 and/or to assist a human driver with driving vehicle 201.

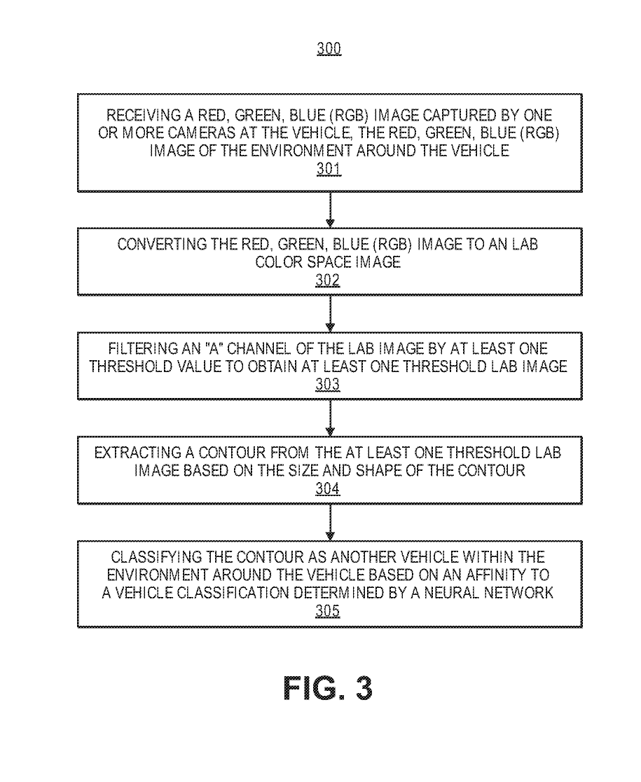

FIG. 3 illustrates a flow chart of an example method 300 for detecting another vehicle in low light conditions. Method 300 will be described with respect to the components and data of low light roadway environment 200.

Method 300 includes receiving a Red, Green, Blue (RGB) image captured by one or more cameras at the vehicle, the Red, Green, Blue (RGB) image of the environment around the vehicle (301). For example, image converter 213 can receive RGB images 231 of low light roadway environment 200 captured by camera(s) 204. RGB images 231 include objects 221A, 221B, and 221C. RGB images 231 can be fused from images captured at different camera(s) 204.

Method 300 includes converting the Red, Green, Blue (RGB) image to an LAB color space image (302). For example, image converter 213 can convert RGB images 231 into LAB frames 233. Method 300 includes filtering an “A” channel of the LAB image by at least one threshold value to obtain at least one thresholded LAB image (303). For example, channel filter 214 can filter an “A” channel of each of LAB frames 233 by at least one threshold value (e.g., 100 pixels, 150 pixels, 200 pixels, etc.) to obtain thresholded LAB images 234.

Method 300 includes extracting a contour from the at least one thresholded LAB image based on the size and shape of the contour (304). For example, contour extractor can extract contours 236 from thresholded LAB images 234. Contours 236 can include contours for at least one but not all of objects 221A, 221B, and 221C. Contours for one or more of objects 221A, 221B, and 221C can be filtered out due to having a size and/or shape that is not likely to correspond to a vehicle relative to other contours in contours 236.

Method 300 includes classifying the contour as another vehicle within the environment around the vehicle based on an affinity to a vehicle classification determined by a neural network (305). For example, neural network 217 can classify contours 236 for any of objects 221A, 221B, and 221C (that were not filtered out by contour extractor 216) into a classification 237. It may be that all the contours for an object are filtered out by contour extractor 216 prior to submitting contours 236 to neural network 217. For other objects, one or more contours can be determined as relevant (or more likely to correspond to a vehicle).

An affinity can be a numerical affinity (e.g., a percentage score) for each class in which neural network 217 was trained. Thus, if neural network 217 were trained on two classes, such as, for example, vehicle and non-vehicle, neural network 217 can output two numeric scores. On the other hand, if neural network 217 were trained on five classes, such as, for example, car, truck, van, motorcycle, and non-vehicle, neural network 217 can output five numeric scores. Each numeric score may be indicative of the affinity of the one or more inputs (e.g., one or more contours of an object) to a different class.

In a decisive or clear classification, the one or more inputs may show a strong affinity to one class and weak affinity to all other classes. In an indecisive or unclear classification, the one or more inputs may show no preferential affinity to any particular class. For example, there may be a “top” score for a particular class, but that score may be close to other scores for other classes.

Thus, in one aspect, a contour can have an affinity to classification as a vehicle or can have an affinity to classification as a non-vehicle. In other aspects, a contour may have an affinity to a classification as a particular type of vehicle, such as, a car, truck, van, bus, motorcycle, etc. or can have an affinity to a classification as a non-vehicle.

Neural network 217 can send classification 237 to vehicle control systems 254. In one aspect, classification 237 classifies object 221B as a vehicle. In response, vehicle control systems 254 can alert a driver of vehicle 201 (e.g., through sound, steering wheel vibrations, on a display device, etc.) that object 221B is a vehicle. Alternately or in combination, vehicle control systems 254 can take automated measures (breaking, slowing down, turning, etc.) to safely navigate low light roadway environment 200 in view of object 221B being a vehicle.

In some aspects, LIDAR sensors 206 also send range data 232 to neural network 217. Range data indicates a range to each of objects 221A, 221B, and 221C. Neural network 217 can use contours 236 in combination with range data 232 to classify objects as vehicles (or a type of vehicle) or non-vehicles.

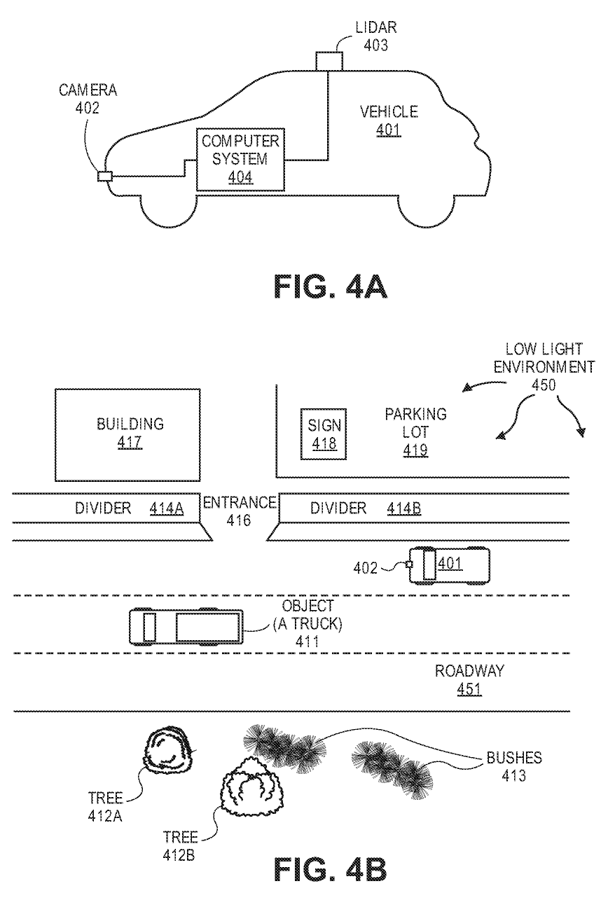

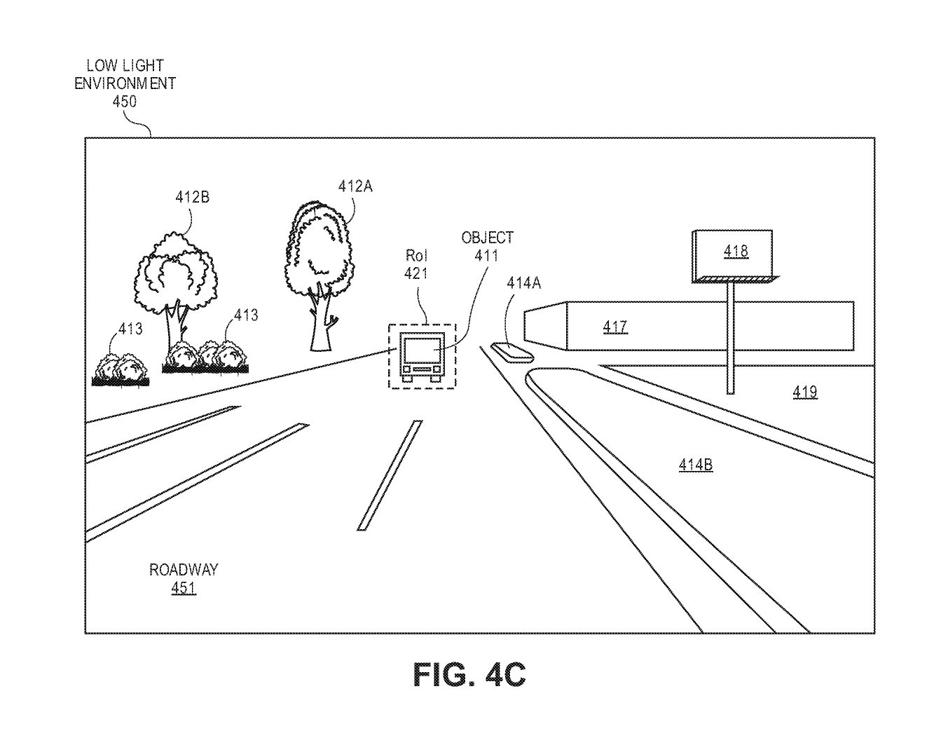

FIG. 4A illustrates an example vehicle 401. Vehicle 401 can be an autonomous vehicle or can include driver assist features for assisting a human driver. As depicted, vehicle 401 includes camera 402, LIDAR 403, and computer system 404. Computer system 404 can include components of a computer vision system including components similar to any of image converter 213, channel filter 214, contour extractor 216, a cropping module, neural network 217, and vehicle control systems 254.

FIG. 4B illustrates a top view of an example low light environment 450 for detecting another vehicle. Light intensity within low light environment 450 can be below a specified threshold causing a low (or no) light condition on roadway 451. As depicted, low light environment 450 includes trees 412A and 412B, bushes 413, dividers 414A and 414B, building 417, sign 418, and parking lot 419. Vehicle 401 and object 411 (a truck) are operating on roadway 451.

FIG. 4C illustrates a perspective view of the example low light environment 450 from the perspective of camera 402. Based on images from camera 402 (and possibly one or more other cameras and/or range data from LIDAR 403), computer system 404 can determine the contours forming the rear of object 411 are likely to correspond to a vehicle. Computer system 404 can identify region of interest (RoI) 421 around the contours forming the rear of object 411. A neural network can classify the contours as a vehicle or more specifically as a truck. With knowledge that object 411 is a truck, vehicle 401 can notify a driver and/or take other measures to safely navigate on roadway 451.

Contours for other objects in low light environment 450, such as, trees 412A and 412B, bushes 413, dividers 414A and 414B, building 417, and sign 418 can be filtered out before processing by the neural network.

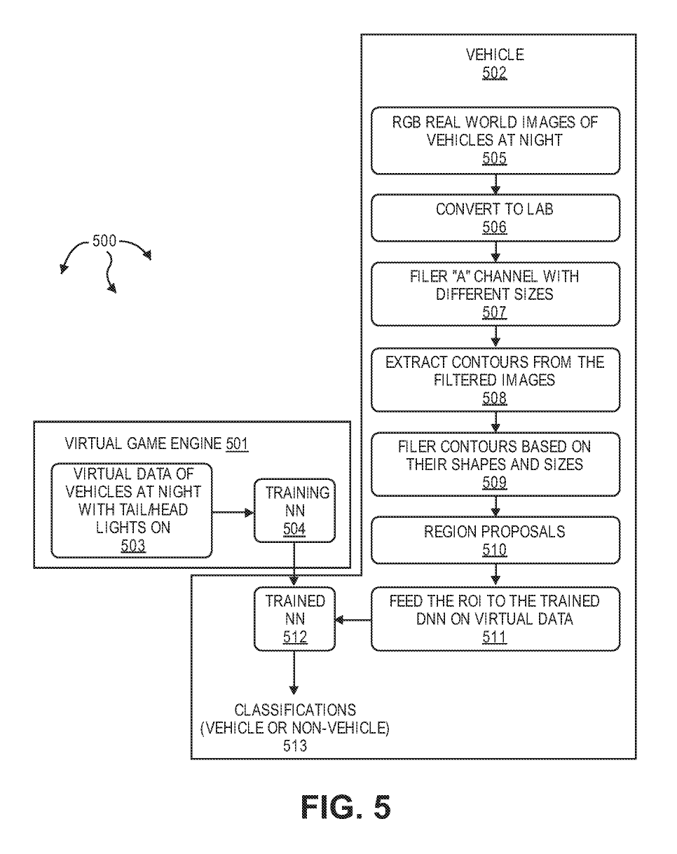

FIG. 5 illustrates a flow chart of an example method 500 for detecting another vehicle in low light conditions. Within a virtual game engine 501, virtual data can be generated for vehicles at night (503). In one aspect, the virtual data is generated for vehicles at night with headlights and/or tail lights on. The virtual data can be used to train a neural network (504). The trained neural network is copied to vehicle 502.

In a vehicle 502, RGB real world images are taken of vehicles at night (505). The RGB real world images are converted to LAB images (506). The LAB images are filtered on the “A” channel with different sizes (507). Contours are extracted from the filtered images (508). The contours are filtered based on their shapes and sizes (509). Regions of interest (e.g., around relevant contours) within the images are proposed (510). The regions of interest are fed to the trained neural network (511). The trained neural network 512 outputs vehicle classifications 513 indicating if objects are vehicles or non-vehicles.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, RGB video, RGB images, LAB frames, LAB images, thresholded LAB images, contours, regions of interest (ROIs), range data, classifications, training data, virtual training data, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, RGB video, RGB images, LAB frames, LAB images, thresholded LAB images, contours, regions of interest (ROIs), range data, classifications, training data, virtual training data, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed:

1. A method for detecting another vehicle in a vehicle environment, comprising:
converting an RGB frame to an LAB frame;
filtering an “A” channel of the LAB frame by at least one threshold value to obtain at least one thresholded LAB image;
extracting at least one contour from the at least one thresholded LAB image; and
classifying, by a neural network, the at least one contour as another vehicle within the environment of the vehicle.

2. The method of claim 1, further comprising formulating the RGB frame from RGB images fused from a plurality of cameras.

3. The method of claim 1, wherein filtering the “A” channel of the LAB frame comprises filtering the “A” channel of the LAB frame with a plurality of different size thresholds.

4. The method of claim 1, wherein extracting at least one contour comprises:
identifying a plurality of contours from the at least one thresholded LAB image; and
filtering the at least one contour from the plurality of contours, the at least one contour having shape and size more likely to correspond to a vehicle relative to other contours in the plurality of contours.

5. The method of claim 1, further comprising identifying at least one region of interest in the at least one thresholded LAB image, including for each of the at least one contours, cropping out a region of interest from the at least one thresholded LAB image that includes the contour.

6. The method of claim 5, wherein classifying, by a neural network, the at least one contour as another vehicle within the environment of the vehicle comprises, for each of the at least one region of interest:
sending the region of interest to the neural network; and
receiving a classification back from the neural network, the classification classifying the contour as a vehicle.

7. The method of claim 1, further comprising;
receiving an RGB image from a camera at the vehicle, the RGB image captured when light intensity within environment around the vehicle was below a specified threshold; and
extracting the RGB frame from the RGB image.

8. The method of claim 1, wherein converting an RGB frame to an LAB frame comprises converting an RGB frame that was captured at night by a camera at the vehicle.

9. The method of claim 1, wherein classifying, by a neural network, the at least one contour as another vehicle within the environment of the vehicle comprises sending the at least one contour along with range data from a LIDAR sensor to the neural network.

10. A vehicle, the vehicle comprising:
one or more processors;
system memory coupled to one or more processors, the system memory storing instructions that are executable by the one or more processors;
one or more cameras for capturing images of an environment around the vehicle the vehicle;
a neural network for determining if contours detected in the environment around the vehicle are other vehicles; and
the one or more processors executing the instructions stored in the system memory to detect another vehicle in a low light environment around the vehicle, including the following:
receive a Red, Green, Blue (RGB) image captured by the one or more cameras, the Red, Green, Blue (RGB) image of the low light environment around the vehicle;
convert the Red, Green, Blue (RGB) image to an LAB color space image;
filter an “A” channel of the LAB image by one or more threshold values to obtain at least one thresholded LAB image;
extract a contour from the at least one thresholded LAB image based on the size and shape of the contour; and
classify the contour as another vehicle within the low light environment around the vehicle based on an affinity to a vehicle classification determined by the neural network.

11. The vehicle of claim 10, wherein the one or more cameras comprising a plurality of cameras and wherein the one or more processors executing the instructions stored in the system memory to receive a Red, Green, Blue (RGB) image comprises the one or more processors executing the instructions stored in the system memory to receive a Red, Green, Blue (RGB) image fused from images captured at the plurality of cameras.

12. The vehicle of claim 10, wherein the one or more processors executing the instructions stored in the system memory to receive a Red, Green, Blue (RGB) image comprises the one or more processors executing the instructions stored in the system memory to receive a Red, Green, Blue (RGB) image from a camera at the vehicle, the Red, Green, Blue (RGB) image captured when light intensity within the environment around the vehicle was below a specified threshold.

13. The vehicle of claim 10, wherein the one or more processors executing the instructions stored in the system memory to extract at least one contour comprises the one or more processors executing the instructions stored in the system memory to:
identify a plurality of contours from the at least one thresholded LAB image; and
filter the at least one contour from the plurality of contours, the at least one contour having shape and size more likely to correspond to a vehicle relative to other contours in the plurality of contours.

14. The vehicle of claim 10, further comprising the one or more processors executing the instructions stored in the system memory to identify at least one region of interest in the at least one thresholded LAB image frame, including for each of the at least one contours, cropping out a region of interest from the at least one thresholded LAB image that includes the contour; and
wherein the one or more processors executing the instructions stored in the system memory to classify the contour as another vehicle within the environment around the vehicle comprise the one or more processors executing the instructions stored in the system memory to:
send the region of interest to the neural network; and
receive a classification back from the neural network, the classification classifying the contour as a vehicle.

15. The vehicle of claim 10, wherein the one or more processors executing the instructions stored in the system memory to classify the contour as another vehicle within the environment around the vehicle comprises the one or more processors executing the instructions stored in the system memory to send the at least one contour along with range data from a LIDAR sensor to the neural network.

16. The vehicle of claim 10, wherein the one or more processors executing the instructions stored in the system memory to classify the contour as another vehicle within the environment around the vehicle comprises the one or more processors executing the instructions stored in the system memory to classify the at least one contour as a vehicle, the vehicle selected from among: a car, a van, a truck, or a motorcycle.

17. A method for use at a vehicle, the method for detecting another vehicle in a low light environment around the vehicle, the method comprising:
receiving a Red, Green, Blue (RGB) image captured by one or more cameras at the vehicle, the Red, Green, Blue (RGB) image of the low light environment around the vehicle;
converting the Red, Green, Blue (RGB) image to an LAB color space image;
filtering an “A” channel of the LAB image by at least one threshold value to obtain at least one thresholded LAB image;
extracting a contour from the thresholded LAB image based on the size and shape of the contour; and
classifying the contour as another vehicle within the low light environment around the vehicle based on an affinity to a vehicle classification determined by a neural network.

18. The method of claim 17, wherein receiving a Red, Green, Blue (RGB) image captured by one or more cameras at the vehicle comprises receiving an a Red, Green, Blue (RGB) image captured by the one or more cameras when the light intensity in the environment around the vehicle was below a specified threshold.

19. The method of claim 18, wherein receiving a Red, Green, Blue (RGB) image captured by the one or more cameras when the light intensity in the environment around the vehicle was below a specified threshold comprises receiving a Red, Green, Blue (RGB) image captured by the one or more cameras at night.

20. The method of claim 18, wherein classifying the contour as another vehicle within the environment around the vehicle comprises classifying the at least one contour as a vehicle, the vehicle selected from among: a car, a van, a truck, or a motorcycle.
